(19) United States
(12) Patent Application Publication
(10) Pub. No.: US 2025/0325921 A1
(43) Pub. Date: Oct. 23, 2025

(54) SAMPLE SEPARATION DEVICE WITH ACTIVELY DAMPING METERING DEVICE

(71) Applicant: Agilent Technologies, Inc., Santa Clara, CA (US)

(72) Inventors: Blasius Nocon, Rheinstetten (DE); Konstantin Shoykhet, Karlsruhe (DE); Karsten Lehradt, Waldbronn (DE); Tobias Meier, Waldbronn (DE)

(21) Appl. No.: 19/183,537

(22) Filed: Apr. 18, 2025

(30) Foreign Application Priority Data
Apr. 22, 2024 (GB) 2405609.5

(51) Int. Cl. B01D 15/14; B01D 15/10

(52) U.S. Cl. CPC B01D 15/14; B01D 15/102

(57) ABSTRACT

A sample separation device for separating a fluidic sample includes a fluid drive arrangement for driving a mobile phase along a flow path to a sample separation unit, a sampler for sampling the fluidic sample, and a control device configured to control the metering device to thereby actively damp a fluctuation in the fluid drive arrangement operation. The sampler may include a metering device.

### CROSS-REFERENCE TO RELATED APPLICATIONS

The present application claims the benefit of UK Patent Application No. GB 2405609.5, filed on Apr. 22, 2024, which is incorporated herein by reference in its entirety.

### TECHNICAL FIELD

The present disclosure relates to a sample separation device for separating a fluidic sample, wherein the sample separation device comprises a fluid drive arrangement for driving a mobile phase along a flow path to a sample separation unit, a sampler for sampling the fluidic sample, wherein the sampler comprises a metering device, and a control device configured to control the metering device to thereby actively damp a fluctuation in the fluid drive arrangement operation. The present disclosure further relates to a method of operating a sample separation device.

### BACKGROUND

Analytical devices are provided for analyzing a sample, for example using a sample separation device.

For example, for liquid separation in a chromatography system, a mobile phase comprising a sample fluid (e.g., a chemical or biological mixture) with compounds to be separated is driven through a stationary phase (such as a chromatographic column packing), thus separating different compounds of the sample fluid which may then be identified.

The mobile phase, typically comprised of one or more solvents, is pumped under high pressure typically through a chromatographic column containing packing medium (also referred to as packing material or stationary phase). As the sample is carried through the column by the liquid flow, the different compounds, each one having a different affinity to the packing medium, move through the column at different speeds. Those compounds having greater affinity for the stationary phase move more slowly through the column than those having less affinity, and this speed differential results in the compounds being separated from one another as they pass through the column. The stationary phase is subject to a mechanical force generated in particular by a hydraulic pump that pumps the mobile phase usually from an upstream connection of the column to a downstream connection of the column. As a result of flow, depending on the physical properties of the stationary phase and the mobile phase, a relatively high-pressure drop is generated across the column.

The mobile phase with the separated compounds exits the column and passes through a detector, which registers and/or identifies the molecules, for example by spectrophotometric absorbance measurements. A two-dimensional plot of the detector measurements against elution time or volume, known as a chromatogram, may be made, and from the chromatogram the compounds may be identified. For each compound, the chromatogram may display a separate curve feature also designated as a “peak”.

Hereby, a precisely controlled fluidic flow through a sample separation system is imperative, in particular for high-performance liquid chromatography (HPLC) systems. This requires (in current HPLC systems) a pump which can provide this high-flow precision and in turn low back-pressure pulsation level against the (possibly variable) flow resistance of the other components of the HPLC systems. This is usually achieved by using a dual-piston pump design, thereby driving each piston independently with active control feedback.

An additional pumping device (a metering device) may be used for metering the sample to be analyzed/separated. In a conventional design, the metering device may be included into the fluid path of the HPLC system most of the time except during the sample up-take and preparation phase.

Two reciprocating piston pumps (connected in series or in parallel) can provide a continuous flow into the analytical system (such as in the dual piston pump design). However, in particular at the turning points of the pistons, the flow may be disturbed or even temporarily discontinued due to the challenges of the pressure alignment of the cylinder starting delivery to the system pressure, thus leading to a certain amount of pressure ripples in the mobile phase provided to the analytical system. A known counter-measure to smoothen pressure ripples in the mobile phase is to add a damper fluidically connected to the high-pressure flow path. A damper is in particular required in the high-pressure flow path to compensate for the pressure ripples and to generate a pulsation-free flow.

FIG. 3 shows a detailed view of a conventional sample separation device 10. The fluid drive arrangement comprises a first fluid drive unit 110 with a first piston 111 in a first pump chamber 113 and a second fluid drive unit 120 with a second piston 121 in a second pump chamber 123. While the first fluid drive unit 110 is connected to the mobile phase/solvent container (not shown) via a fluidic check valve, the second fluid drive unit 120 is coupled to the sampler 40 and coupleable to the sample separation unit 30. Process direction upstream of the first fluid drive unit 110, there is arranged a first check valve and process direction upstream of the second fluid drive unit 120, there is arranged a second check valve. In this example, the first piston 111 is driven by a first drive unit 115, while the second piston 121 is driven by a second drive unit 125, both drive units 115, 125 (e.g., ball-screws) being coupled via a common gear system to a common motor 126. Using the gear system, the drive units 115, 125 can operate in a different manner, thereby enabling a continuous flow (of mobile phase). This configuration can be termed a dual piston pump system. The first drive unit 115, the second drive unit 125, and the common motor 126 can be seen as a drive unit system.

The second fluid drive unit 120 is coupled to a fluid valve 112, in particular a switching valve (e.g., part of the sampler 40). A pressure sensor 140 may be provided in the high-pressure flow path, i.e., between the outlet check valve in the pump and the fluid valve 112 to monitor the pump/system pressure. The switching valve enables at least two operation modes: main pass and bypass. In the main pass mode, the fluid drive arrangement is coupled via sample loop 106 to the sample separation unit 30. In the bypass mode, the fluid drive arrangement is only coupled with the sample separation unit 30, while the sample loop 106 is isolated from the high-pressure path and can be in sample uptake mode (or, alternatively, a purge, cleaning, or conditioning operation may be performed).

The sampler 40 comprises a metering device 130 to take up fluidic sample, e.g., from a sample container using a sample needle. The sample can be stored in a sample accommodation volume 106, e.g. a sample loop. The sample can be introduced into the sample separation unit 30 via a needle seat 41. For example, mobile phase driven by the fluid drive arrangement in the main pass operation mode of the valve 112 can flush the sample from the sample loop 106 towards or into the sample separation unit 30. The sampler 40 can further comprise for example a needle wash port 102, a waste line 101, or a wash pump 103.

In order to reduce/eliminate fluctuations in the fluid drive arrangement, it may be required to provide an additional damping device 160. In this example, the first fluid drive unit 110 and the second fluid drive unit 120 are connected (fluidically) in series via the damper device 160.

The damper performance improves with increasing damper volume and/or elasticity, but this also increases the system dead volume, resulting in an increase in and pressure-dependence of the delays and poorer consistency of analysis results. Further, the damper device requires additional space and further (material and maintenance) costs.

DE 102014103766 A1 (which is incorporated herein by reference in its entirety) describes usage of the metering pump, when switched into the high-pressure path, as a given delay volume in order to emulate behavior of a different HPLC system. However, the metering device is not used as a damper, in particular not an active damper for fluctuations caused by the analytical pump.

### SUMMARY

There may be a need to dampen fluctuations in a fluid drive arrangement operation in an (cost-) efficient and reliable manner, such as in the context of a sample separation device and a method.

According to an aspect of the disclosure, there is described a sample separation device (e.g., a chromatographic device, in particular an HPLC device/system) for separating a fluidic sample, the sample separation device comprising:
i) a fluid drive arrangement (in particular a pump system, for example comprising a dual piston pump design) for driving a mobile phase along a (high-pressure) flow path to a sample separation unit (e.g., a chromatographic column).
ii) a sampler (e.g., comprising a sample injection space comprising a robotic arm with a sample needle) for sampling the fluidic sample, wherein the sampler comprises a metering device (e.g., a metering or dosing pump, in particular connectable to the high-pressure path).
iii) a control device (e.g., a processor, a controller, a control system, etc.) configured to control (this may include a regulation) the metering device to thereby actively damp (a fluctuation, in particular regarding pressure/flow, in) (caused by (limitations of)) the fluid drive arrangement operation.

According to a further aspect of the disclosure, there is described a method of operating a sample separation device, the method comprising: i) driving a mobile phase along a flow path to a sample separation unit by a fluid drive arrangement, and ii) controlling a metering device of a sampler of the sample separation device to thereby actively damp a fluctuation (caused by limitations) of the fluid drive arrangement operation.

According to a further aspect of the disclosure, there is described a use (method of using) of a metering device of a sampler to actively damp fluctuations in the operation of a fluid drive arrangement in a chromatography device.

In the context of this document, the term “fluidic sample” may particularly denote any liquid and/or gaseous medium, optionally including also solid particles, which is to be analyzed. Such a fluidic sample may comprise a plurality of fractions of molecules or particles which shall be separated, for instance small-mass molecules or large-mass biomolecules such as proteins. Separation of a fluidic sample into fractions involves a certain separation criterion (such as molecular mass or volume, chemical properties, etc.) according to which a separation is carried out.

In the context of this document, the term “mobile phase” may particularly denote any liquid and/or fluidic, e.g. super-critical, medium which may serve as fluidic carrier of the fluidic sample during separation. A mobile phase may be a solvent or a solvent composition (for instance composed of water and an organic solvent such as ethanol or acetonitrile). In an isocratic separation mode of a liquid chromatography apparatus, the mobile phase may have a constant composition over time. In a gradient mode, however, the composition of the mobile phase may be changed over time, in particular to desorb fractions of the fluidic sample which have previously been adsorbed to a stationary phase of a separation unit.

In the context of this document, the term “sample separation device” may particularly denote any apparatus which is capable of separating different fractions of a fluidic sample by applying a certain separation technique, in particular liquid chromatography.

The term “sample separation unit” may particularly denote a fluidic member through which a fluidic sample is transferred and which is configured so that, upon conducting the fluidic sample through the separation unit, the fluidic sample will be separated into different groups of molecules or particles according to their properties. An example for a separation unit is a liquid chromatography column which is capable of trapping or retarding and selectively releasing different fractions of the fluidic sample.

In the context of this document, the term “sampler” may in particular refer to a portion/domain of the sample separation device that is dedicated to sample handling, in particular sample injection. For example, a sampler can comprise a sample handling device, such as a robotic arm, to move fluidic sample in a sampling space. The sample handling device may comprise a sample needle in order to suck fluidic sample from a sample container and to inject the collected sample into a sample injection path of the sample separation device. The sample handling device may be arranged to mechanically transport the sample between the sample container and a needle seat (coupled to or constituting a part of the sample injection path). The sample needle may be coupled to a sample accommodation volume/unit, e.g. sample loop, in which the collected sample can be temporally stored. In an embodiment, the sampler comprises a metering device, coupled to the sample needle and the sample accommodation volume, and configured to draw a specific amount of sample via the sample needle into the sample accommodation volume.

In the context of this document, the term “metering device” may in particular refer to a device configured to (accurately) measure and/or deliver a specific volume of fluidic sample. In an embodiment, the metering device may be configured as a (metering or dosing) pump that can handle small fluid volumes with high precision. For this purpose, the metering device may comprise a piston and a piston chamber/volume. In an example, the metering device may be coupled with the sample accommodation volume and/or the sample needle. When the sample is injected into the sample separation system, the metering device may be connected to or into the high-pressure path in the section of the high-pressure path between the fluid drive arrangement and the sample separation unit (e.g., in a main pass configuration). In an embodiment, the fluid flow (in particular the mobile phase) from the fluid drive arrangement may flow through the metering device and then through the sample accommodation volume to flush out the fluidic sample accommodated in the sample accommodation volume (flow-through configuration). In an embodiment, the metering device can be fluidically connected to the high-pressure path with only one fluid conduit, thus not being part of a flow-through path but rather an “appendix”. The metering pump may be configured as a high-pressure syringe pump or a high-pressure plunger pump or another type of a high-pressure displacement pump, being typically part of the sample injector, which is used for metering sample fluid into a sample loop. The content of the sample loop can then be introduced into the flow of the mobile phase for chromatographic analysis, which comprises separation of the injected sample by the chromatographic column.

In the present context, the metering device may be configured to act as an active damper device. In an example, the metering device may be specifically configured for this task, for example with respect to the steering algorithm and precise operation coordination with other elements of the sample separation device, in particular with the fluid drive arrangement, but also with respect to speed, size, power, or pressure. In a further example, the metering device may be configured for a dynamic operation and/or for providing a variable stroke.

In an embodiment, the metering device comprises a piston and may be configured to forward and retract the piston, in particular under operating pressure.

In the context of this document, the term “sample accommodation volume” may particularly denote a defined portion or section of a flow path, a fluidic conduit or a fluidic member (such as a fluidic valve) in which a predefined amount of fluid may be at least temporarily/temporally accommodated. In an embodiment, the fluid accommodation volume may be a sample loop (e.g., fluidically connected to ports of an injection valve). The fluid accommodation volume may be at least temporarily fluidically decoupled from a flow path or main path. By a switching mechanism, the sample accommodation volume may be first coupled to a certain location in a sample separation device, while being later alternatively or additionally coupled to a different location in the sample separation device.

In the context of this document, the term “fluid drive arrangement” may particularly denote a device configured to drive a fluid along a flow path. In an embodiment, a fluid drive arrangement may comprise at least one fluid drive unit which may be realized as a pump unit. In a basic example, a fluid drive unit may comprise one pump unit with a piston and a respective piston cylinder (pump volume/chamber) (and a respective motion source such as a motor). In a further example, a fluid drive arrangement may comprise two (or more) fluid drive units, e.g., two piston cylinders with respective pistons (e.g., a dual piston pump) (and a common motion source). In an example, a fluidic drive arrangement may be described as a pumping appliance comprising—in the case of a piston or plunger pump—one or a plurality of the pump cylinders with pistons or plungers (pump units). In particular, the pump units of a fluid drive arrangement may be driven by a single motion/energy source, e.g. by a single motor. Accordingly, in an example, the pump units (e.g., piston/cylinder pairs) of a fluid drive arrangement may be mechanically dependent and may not be driven independently (due to their mechanical coupling).

In the context of this document, the term “damping” may particularly refer to a damping (e.g., using a damping device or a metering device) of fluctuations of pressure and/or flow of an operation of the fluid drive arrangement (in particular the chromatographic pump).

In the context of this document, the term “actively damp” may particularly denote a damping operation (with respect to a fluid drive arrangement) that is done actively, i.e by involvement of a dedicated steering or control mechanism and/or of an external volume displacement drive. For example, moving the piston of a metering device in a specific manner (with the specific purpose of damping in this manner) to thereby perform a damping operation may be considered an active damping. In contrast, a passive damping device (e.g., an elastic element in the fluidic path, in particular a volume filled with a liquid, either fluidically or mechanically (i.e., for example separated by a membrane) coupled to the high-pressure path, which needs damping) may also fulfill a damping operation but without any interaction (in particular no application of an external energy source or a drive such as a motor), i.e. not active. An active damping may for example include an active movement of an element, such as the piston of a pump. Further, an active damping may require that the movement follows a specific purpose such as providing more volume, when a fluid flow comprises less volume and vice versa. An active damping may be supported for example by a sensor, such as a pressure sensor, so that a regulation may be implemented.

The term “flow path” may be understood in this context as a fluidic path engaged (in a present switching and configuration state of the sample separation device) in fluid transport, e.g. from a fluid drive arrangement to a sample separation unit.

According to an exemplary embodiment, the disclosure may be based on the idea that fluctuations (regarding pressure/flow) of a fluid drive arrangement operation in a sample separation device (in particular an HPLC device/system) can be damped in an (cost-) efficient and reliable manner, when the metering device of the sampler of the sample separation device is used (in the main pass configuration) to actively damp the fluctuations.

Conventionally, the metering device of the sampler is only applied to draw a specific amount of fluidic sample into the sample accommodation volume. It has been surprisingly found by the inventors that such metering device can be used in a highly efficient and reliable manner for actively damping (e.g., by moving the piston in a specific manner) fluctuations in the flow path caused by the fluid drive arrangement (e.g., a dual piston pump). Thereby, an additional damping device (see e.g. FIG. 3), which is generally required, may become unnecessary, whereas the precision of the damping may be improved. Thus, costs, efforts and space may be saved according to the present disclosure.

The metering device may serve as a volume displacement unit and can be used to compensate flow artifacts and thus to eliminate or suppress pressure ripples. Further, by using the metering device as an active damper, the dead volume of the system may be significantly reduced, as a large-volume passive damper can be eliminated. The damping can be more precise since the damping operation can be actively controlled and adjusted. Due to the elimination of the damper, the production costs may be reduced.

The disclosure may enable a reduction of complexity and costs of sample separation systems and/or enhance the performance with low or no additional cost. Compared to previous approaches, the disclosure may require less components and reuse already existing sub-units of a sample separation device to perform multiple tasks instead of single task per sub-unit. Hence, the disclosure may provide a significant cost-saving potential over current architectures/operation modes.

### EXEMPLARY EMBODIMENTS

In an embodiment, the control device is configured to control the metering device and the fluid drive arrangement in a coordinated, in particular in a synchronized, manner. In an embodiment, the method further comprises coordinating, in particular synchronizing, the operation of the fluid drive arrangement and the active damping by the metering device.

Thereby, the efficiency and reliability of the active damping may be further increased. In an example, there might be a control device for the metering device and another control device for the fluid drive arrangement, while both are coordinated/synchronized by a third control device or by a direct communication of the control devices, in particular by negotiation of the control devices or by master-slave communication of the control devices; in the latter case, the drive arrangement control device may be arranged as master. In another example, the fluid drive arrangement and the metering device may be controlled by the same control device (e.g., a system control device), thereby enabling an efficient coordination. In a specific example, the firmware of the metering device and the firmware of the fluid drive arrangement are coupled.

When the operation of the active damper (metering device) and the fluid drive arrangement (pump drives) is coordinated, it may be possible to make the critical phase, most requiring active damping, longer in time and thus easier to coordinate the control devices and the corresponding drives. The required motion speeds and accelerations in the drives can thus be reduced and the operation can become better controllable. This can be advantageous for precise control and coordination of the operation of the fluid drive arrangement and the active damper. Further, stress and requirements to the fluid drive arrangement and controlling mechanisms may be significantly reduced.

In an embodiment, actively damping comprises at least one of: balancing pressure, balancing pressure ripples, balancing flow or total fluid displacement, balancing flow ripples, avoiding fluctuations, correcting a pressure change, in particular a pressure jump, correcting a momentary flow rate change, in particular a flow rate jump, especially a flow dip, disruption or reversal, taking up fluid volume if the fluid flow is too high/strong, providing fluid volume if the fluid flow is too low/weak. Thus, common fluctuations of pressure/flow caused by the fluid drive arrangement may be overcome in an efficient and reliable manner.

In a specific example, the piston-coupled pump may have a flow dip or even disruption or reversal, while the primary piston (of the fluid drive arrangement) is compressing the fresh solvent and the secondary piston is not delivering any longer, because its motion is reverse-coupled with the motion of the primary piston. Different piston-coupled pumps, e.g., a single-motor dual-piston cam-shaft pump, may produce flow spikes in the delivery overlap phase of the pistons. The metering device acting as active damper would provide the missing volume or intake (accommodate) the excessive volume during such disturbance phases and, respectively, draw or eject the expended volume during the rest of the pump cycle.

In an embodiment, actively damping comprises moving a piston of the metering device in a coordinated manner, in particular coordinated with at least one of the piston movement of the fluid drive arrangement (pump), the duty cycle of the pump, or a derivative of that. In the present context, the term “coordinated” may in particular refer to a coordination with the piston movement or the duty cycle of the pump or to a derivative of that (i.e., to compensate for phase shift). It has been found by the inventors that the active movement of the metering device piston, in particular coordinated/synchronized with the fluid drive arrangement operation (i.e., during the operation of the fluid drive arrangement) may provide a surprisingly efficient damping.

In an embodiment, (at least in a main pass configuration) the fluid drive arrangement is coupled with the sample separation unit via the metering device (see also FIG. 4A). In this configuration, a high-pressure path may be established between the fluid drive arrangement and the sample separation unit, so that the mobile phase is streamed along the flow path. The mobile phase may stream through the metering device (piston/pump chamber) and then through the sample accommodation volume, thereby flushing out an accommodated sample (flow-through configuration). This may provide the advantage that the metering device is directly coupled into the (high-pressure) flow path, so that fluctuations (caused by the fluid drive arrangement) may be actively compensated for.

In an embodiment, (at least in the main pass configuration) the flow path extends through the metering device. Also in this configuration, the metering device may be coupled into the same flow path as the fluid drive arrangement, so that the active damping can be enabled.

In an embodiment (at least in a main pass configuration) the metering device is fluidically coupled to the flow path connecting the fluid drive arrangement and the sample separation unit.

In an embodiment, (at least in a bypass configuration) the fluid drive arrangement is decoupled from the metering device and coupled to the sample separation unit. In an example, the active damping may be done only in the main pass configuration. In the bypass configuration (sampler, in particular metering device, is decoupled from the high-pressure path to the separation unit), damping may be less crucial since it is possible to conduct analysis such that the separation is run entirely in the main pass configuration. Thus, no ripple-related artifacts may be present in the chromatogram.

In an embodiment, it is also possible to couple the metering device to or into the (high-pressure) flow path, whereas the sample accommodation unit with an in-taken sample temporarily remains decoupled from the high-pressure flow path. This may be beneficial in order to establish an actively damped flow through the sample separation unit already in advance before applying the sample to the sample separation unit.

In an embodiment, the fluid drive arrangement comprises a first fluid drive unit and a second fluid drive unit. In an embodiment, the first fluid drive unit and the second fluid drive unit are fluidically coupled with each other, in particular in series or in parallel. The first fluid drive unit and the second fluid drive unit may be coupled to provide a dual piston pump (reciprocating pumps) that establishes a continuous flow into the separation system. The dual piston pump mechanism, especially with mechanical coupling between the pistons, may cause pressure ripples which are normally unacceptable for modern chromatography, so that conventionally a passive damper device is required.

Operation of the two pumps connected in series is for example like this: in an initial cycle phase, the first pump sucks in fluid. In the next cycle phase, the first pump pressurizes the fluid (to system pressure) and supplies the pressurized fluid towards the second pump and the system (i.e., the outlet of the two pumps, namely the high-pressure flow path (of the mobile phase)) towards the chromatography column. A portion of the supplied pressurized fluid is sucked in by the second pump, and the remaining portion is supplied into the system. In the next cycle, the first pump can again suck in fluid while at the same time the second pump supplies the pressurized fluid into the system. By this, the two reciprocating pumps can provide a continuous flow into the system. However, in particular at the turning points of the pistons, the flow may not be entirely continuous or may even be halted or reversed during the pressurization phase of the first pump, thus leading to a certain amount of pressure ripples in the mobile phase provided to the system.

In an embodiment, the sample separation device further comprises a switching unit/device, in particular a fluid (switching) valve to couple and/or decouple the fluid drive arrangement and the metering device, in particular to switch between the main pass configuration and the bypass configuration. Switching devices such as valves (e.g., a rotary valve, a shear valve, etc.) may be well known in the field of chromatography. A switching valve may be an efficient and reliable tool to establish different flow paths, wherein a coupling between fluid drive arrangement and metering device may be used for the active damping.

In an embodiment, the switching device (fluid valve) is configured for allowing the metering device to draw fluidic sample into a sample accommodation unit/volume while being fluidically decoupled from the high-pressure path (see bypass configuration).

In an embodiment, the switching device (fluid valve) is configured for fluidically coupling the fluid drive arrangement (chromatographic pump) and the sample separation unit (chromatographic column), in particular in the high-pressure path, and introducing the sample accommodation unit into the high-pressure path in a flow-through mode (see main pass configuration).

In an embodiment, the switching device (fluid valve) is configured to allow introduction of the sample into the high-pressure path in feed injection mode (direct injection of the sample into the high-pressure mobile phase). In an embodiment, the switching device (fluid valve) and the fluidic path(s) are configured to allow introduction of the sample into the high-pressure path in a feed injection mode. In the feed injection mode, the sample fluid flow is introduced from a side fluidic path into the continuous and continued flow of the mobile phase in the fluidic path between the fluid drive arrangement (chromatographic pump) and the sample separation unit (chromatographic column). The flow rate of the mobile phase may be adjusted during the sample introduction.

In an embodiment, the switching device (fluid valve) is configured to allow pressurizing and/or depressurizing the sample accommodation unit while being decoupled from the high-pressure path (see bypass configuration). Such a pre-pressurizing may improve the coupling to the high-pressure path (see main pass configuration).

In an embodiment, the sample separation device comprises a pressure sensor (in particular a pressure sensor of the fluid drive arrangement). In an embodiment, the sample separation system comprises at least one of: a pressure sensor of the fluid drive arrangement, a pressure sensor permanently or temporally connected to or into the high-pressure flow path or sub-sections thereof, and a pressure sensor of the sampler. In an embodiment, the sample separation device comprises a flow sensor.

In an embodiment, the control device is configured to control the metering device at least partially based on at least one pressure measurement of the pressure sensor (and/or a flow measurement of a flow sensor). Thereby, the active damping (specifically with respect to the coordination) may be improved. Data from such a sensor may be used as a starting point for controlling the damping operation. In a further embodiment, data from such a sensor may be used for a regulation of the damping operation (e.g., with continuous feedback from the sensor). In an embodiment, no additional sensor is applied, but the sensor(s) already present in the sample separation device (e.g., the pressure sensor of the fluid drive arrangement) may be applied, thus saving costs.

In an embodiment, the control device is configured to control the metering device at least partially based on at least one of: at least one pressure measurement of the pressure sensor, a model predicting the fluid volume displaced by the fluid drive arrangement over time, and calculated or measured (e.g., by means of a position sensor or encoder in the fluid drive arrangement) pistons position of the fluid drive arrangement.

In an embodiment, the sample separation device is free of a (dedicated, passive) damping device (in particular the fluid drive arrangement is free of such damping device). The metering device may be applied in such a manner as the active damping device, so that a further (passive) damping device may become obsolete. It follows that material and maintenance costs can be saved, as well as space in the sample separation device.

In an embodiment, the sample separation device is configured so that a/the dead volume is adjustable with/using the metering device. In a further embodiment, the metering device is configured to provide a specific dead volume or flow-through volume or a specific delay volume. In an embodiment, the dead volume adjustment may be done for an instrument emulation mode.

As described in DE 102014103766 A1, a metering device may be configured to a specific volume, e.g., by stopping the piston at a certain position without further piston motion. In an embodiment, the starting position, the central position, or the position range for the piston motion of the metering device piston applied to compensate for the ripple may be selected in order to adjust the dead or delay volume of the system in order to emulate. Such adjustment is possible, because typically the necessary magnitude of the piston motion needed for compensation of the pulsations is significantly smaller than the total volume of the metering device. Thus, the operation can be configured such that the piston is operating e.g. in the nearly fully driven-in state or nearly fully driven out, providing thus different effective (average) delay volume(s).

In other words, in flow-through injection mode, the mobile phase flows through the metering device on its way down to the column. On adjusting the position of the metering device piston, the delay volume is adjusted as well, i.e., the more the piston is pulled out the larger the delay volume is. Because the geometry of the metering device is well-known and the piston position can be precisely set, the delay volume of another type of injector can be emulated by moving the piston to a certain position and keeping it at that position during the run.

An interesting application may be in quality/manufacture control (e.g., of pharmaceutical products), wherein the same measurement parameters have to be used for many years to keep the standards. Even if a new instrument is used, the operation of the old (and standardized) instrument may be efficiently emulated. In the present case, the metering device may also serve to provide such a (instrument specific) dead volume, along with its functionality as an active damper device. Accordingly, two advantageous applications may be implemented within one and the same device.

In an embodiment, a mobile phase, in particular a solvent, is drawn by the first fluid drive unit (in particular from a solvent container) and is then streamed to the second fluid drive unit. In an embodiment, the first and the second fluid drive units are coupled with their respective outlets and are controlled to provide a flow into the system in an alternating manner, thus generating an essentially continuous flow over time. In an embodiment, the mobile phase is streamed, in process direction downstream of the fluid drive arrangement, through a sample accommodation volume of the sampler, thereby flushing out the fluidic sample accommodated in the sample accommodation volume by the mobile phase. This flow-through configuration may be common in the field of chromatography, so that the present disclosure may be directly implemented in established and economically important applications.

In an embodiment, the sampler is configured for introducing the fluidic sample into the mobile phase. This can be done for example in a flow-through configuration or a feed-injection configuration. The metering device may serve the purpose of using a specific amount of sample (metering or dosing). Yet, the metering device may also serve the purpose of an active damping device.

In an embodiment, the metering device is configured for moving the fluidic sample (e.g., from a sample container into a sample loop before then being introduced into the mobile phase). In an embodiment, the metering device is configured for pressurizing or depressurizing the sample accommodation volume before/after introduction of the fluidic sample into the mobile phase. Such an application may be advantageous to prepare the sample for introduction to the high-pressure path.

In an embodiment, the active damping is provided, when the metering device is in fluid communication (in particular in a high-pressure path) with the fluid drive arrangement (e.g., in the main pass configuration). The metering device may not always be within the high-pressure path from the chromatographic pump, e.g. in a bypass configuration, the metering device may be decoupled for sample handling.

In an embodiment, the first fluid drive unit and/or the second drive unit are connected to a common motion source, in particular a motor. In an embodiment, the first fluid drive unit and/or the second drive unit are mechanically dependent from each other. In an embodiment, the first fluid drive unit is arranged in process direction upstream of the second fluid drive unit. The drive units may be configured as a dual piston pump that establishes a continuous fluid stream to the separation system.

In an embodiment, the metering device is controlled (in particular regulated) dynamically. Specifically, the metering device is coordinated with the fluid drive arrangement, so that the active damping operation may be optimized to the actual needs.

In an exemplary embodiment, the metering device acts as a third pump by actively modulating the flow from the first and second pumps. The flow of the third pump is controlled so that the sum of flows downstream to the third pump (and before the chromatography column) corresponds to the target flow of the mobile phase. In other words, when the flow rate of the mobile phase is targeted to be constant, the third pump (metering device) will provide a negative flow in case the first two pumps provide a higher flow (e.g., a flow ripple resulting from the reciprocating movement), and the other way around, so that the summary flow rate after the third pump remains constant.

In particular, the total flow of the first two pumps may be equal to the desired (commanded) value in average over each pump cycle, whereas it may occur or may be configured to be higher than required in one pump cycle phase and may occur or may be configured to be lower than required in the other pump cycle phase, such that the third pump can modulate the flow to a (desired) constant value by alternatingly intaking and displacing the fluid in coordination with the first two pumps.

In an embodiment, if possible, the piston of the metering device may be placed as closest to the most inserted position in order to reduce dead volume, in particular the piston may be completely inserted into the respective cylinder. In an embodiment, the metering device might be used as an active membrane dampening device. In such a configuration, a solvent/fluid may not flow through the metering device, but the metering device is coupled to the flow path at a junction comprising a membrane. Thus, when the metering device is operating, no fluid is drawn in by the metering device, yet the membrane is deflected. A controlled deflection of the membrane can likewise be used for dampening fluctuations in the flow path.

In an embodiment, the sample separation device is configured as a fluidic chromatography device, more in particular a high-performance liquid chromatography, HPLC, device.

In preparative chromatography systems, a liquid as the mobile phase is provided usually at a controlled flow rate (e.g. in the range of 1 mL/min to thousands of mL/min, e.g. in analytical scale preparative LC in the range of 1-5 mL/min and preparative scale in the range of 4-200 mL/min) and at pressure in the range of tens to hundreds bar, e.g. 20-600 bar.

In high performance liquid chromatography (HPLC), a liquid as the mobile phase has to be provided usually at a very controlled flow rate (e.g., in the range of microliters to milliliters per minute) and at a high pressure (typically 20-100 MPa, 200-1000 bar, and beyond, up to currently 200 MPa, 2000 bar) at which compressibility of the liquid becomes noticeable.

In analytical devices, specifically in liquid chromatography (in particular HPLC), it may be important to provide an accurate solvent flow, even in the case that specific properties of the solvent are not known or are not downloaded to the control unit of an analytical device.

Embodiments may be implemented in conventionally available HPLC systems, such as the analytical Agilent 1260 Infinity II LC system or the Agilent 1290 Infinity II Preparative LC system (both provided by the applicant Agilent Technologies—see www.agilent.com).

One embodiment of a sample separation apparatus comprises a pump having a pump piston for reciprocation in a pump working chamber to compress liquid in the pump working chamber to a high pressure at which compressibility of the liquid becomes noticeable. This pump or the control unit may be configured to process numeric values of solvent properties (such values being provided to the pump by means of operator's input, notification from another module of the instrument or similar, or the pump elsewise derives solvent properties before or during its operation).

The sample separation unit of the sample separation apparatus may comprise a chromatographic column (see for instance en.wikipedia.org/wiki/Column_chromatography) comprising a stationary phase. The column may be a glass or steel tube (for instance with a diameter from 50 μm to 5 mm and a length of 1 cm to 1 m) or a microfluidic column (as disclosed for instance in EP 1577012 (which is incorporated herein by reference in its entirety) or the Agilent 1200 Series HPLC-Chip/MS System provided by the applicant Agilent Technologies). The individual components are retained by the stationary phase differently and at least partly separate from each other while they are propagating at different speeds through the column with the eluent. At the end of the column, they elute one at a time or at least not entirely simultaneously. During the entire chromatography process, the eluent may be also collected in a series of fractions. The stationary phase or adsorbent in column chromatography usually is a solid material. The most common stationary phase for column chromatography is silica gel, surface-modified silica gel, followed by alumina. Cellulose powder has often been used in the past. Most common chromatography modes are ion exchange chromatography, reversed-phase chromatography (RP), affinity chromatography or expanded bed adsorption (EBA). The stationary phases are usually fine powders or gels and/or are microporous for an increased surface.

The mobile phase (or eluent) can be a pure solvent or a mixture of different solvents (such as water and an organic solvent such as ACN, acetonitrile). It can be chosen for instance to adjust the retention of the compounds of interest and/or the amount of mobile phase to run the chromatography. The mobile phase can also be chosen so that the different compounds or fractions of the fluidic sample can be separated efficiently. The mobile phase may comprise an organic solvent like for instance methanol or acetonitrile, often diluted with water. For gradient operation, water and organic solvent are delivered in separate containers, from which the gradient pump delivers a programmed blend to the system. Other commonly used solvents may be isopropanol, tetrahydrofuran (THF), hexane, ethanol and/or any combination thereof or any combination of these with aforementioned solvents.

A fluidic sample analyzed by a sample separation device according to an exemplary embodiment of the disclosure may comprise but is not limited to any type of process liquid, natural sample like juice, body fluids like plasma or it may be the result of a reaction like from a fermentation broth.

The pressure, as generated by the fluid drive, in the mobile phase may range from 2-200 MPa (20 to 2000 bar), in particular 10-150 MPa (150 to 1500 bar), and more particularly 50-120 MPa (500 to 1200 bar).

The sample separation device, for instance an HPLC system, may further comprise a detector for detecting separated compounds of the fluidic sample, a fractionating unit for outputting separated compounds of the fluidic sample, or any combination thereof. For example, a fluorescence detector may be implemented.

Embodiments of the disclosure have been described mainly with respect to a flow injection configuration. However, the present disclosure may also be implemented with a feed injection configuration. Such a feed injection is for example described in EP 3252464, which is incorporated herein by reference in its entirety.

Embodiments of the present disclosure may be partly or entirely embodied or supported by one or more suitable software programs or products, which can be stored on or otherwise provided by any kind of non-transitory medium or data carrier, and which might be executed in or by any suitable data processing unit such as an electronic processor-based computing device (or system controller, controller, control unit, device or apparatus for data processing, etc.) that includes one or more electronic processors and memories. Software programs or routines (e.g., computer-executable or machine-executable instructions or code) may be applied in or by the control unit, e.g. a data processing system such as a computer, such as for executing any of the methods described herein.

Other objects and many of the attendant advantages of embodiments of the present disclosure will be readily appreciated and become better understood by reference to the following more detailed description of embodiments in connection with the accompanying drawings. Features that are substantially or functionally equal or similar will be referred to by the same reference signs.

### BRIEF DESCRIPTION OF THE DRAWINGS

FIG. 1 shows a liquid sample separation device in accordance with embodiments of the present disclosure, particularly used in high-performance liquid chromatography (HPLC).

FIG. 2 shows a sample separation device without a damping device, in accordance with embodiments of the present disclosure.

FIG. 3 shows a conventional sample separation device with a damping device.

FIG. 4A shows a sample separation device in main pass configuration, while FIG. 4B shows the sample separation device in bypass configuration, according to exemplary embodiments of the present disclosure.

FIG. 5 illustrates in a signal/time diagram the effect of an active damping metering device, according to exemplary embodiments of the present disclosure.

The drawings are schematic.

### DETAILED DESCRIPTION

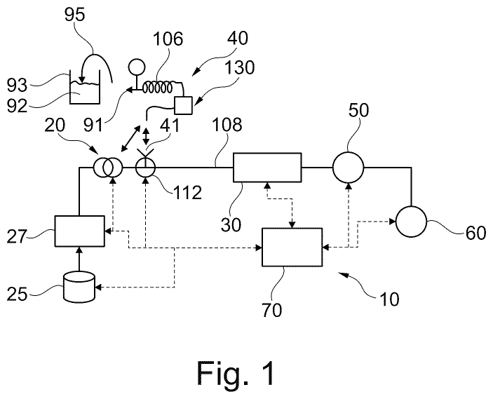

FIG. 1 depicts a general schematic of a liquid separation system as example for a sample separation device 10 according to an exemplary embodiment of the disclosure. A pump as fluid drive arrangement 20 receives a mobile phase from a solvent supply 25, typically via a degasser 27, which degases and thus reduces the amount of dissolved gases in the mobile phase. The mobile phase drive or fluid drive arrangement 20 drives the mobile phase through a sample separation unit 30 (such as a chromatographic column) comprising a stationary phase. A sampler or injector 40, comprising a fluidic valve 112, can be provided between the fluid drive arrangement 20 and the separation unit 30 in order to subject or add (often referred to as sample introduction) a sample fluid into the mobile phase. The stationary phase of the separation unit 30 is configured for separating compounds of the sample liquid. A detector 50 is provided for detecting separated compounds of the sample fluid. A fractionating unit 60 can be provided for outputting separated compounds of sample fluid.

While the mobile phase can comprise one solvent only, it may also be mixed from plural solvents. The corresponding mixing process might be a low-pressure mixing and provided upstream of the fluid drive arrangement 20, so that the fluid drive arrangement 20 already receives and pumps the mixed solvents as the mobile phase. Alternatively, the fluid drive arrangement 20 may comprise plural individual pumping units or fluid drive units, each receiving and pumping a different solvent or mixture, so that the mixing of the mobile phase (as received by the separation unit 30) occurs at the high-pressure side and downstream of the fluid drive arrangement 20 (or as part thereof). The composition (mixture) of the mobile phase may be kept constant over time, the so-called isocratic mode, or varied over time, the so-called gradient mode.

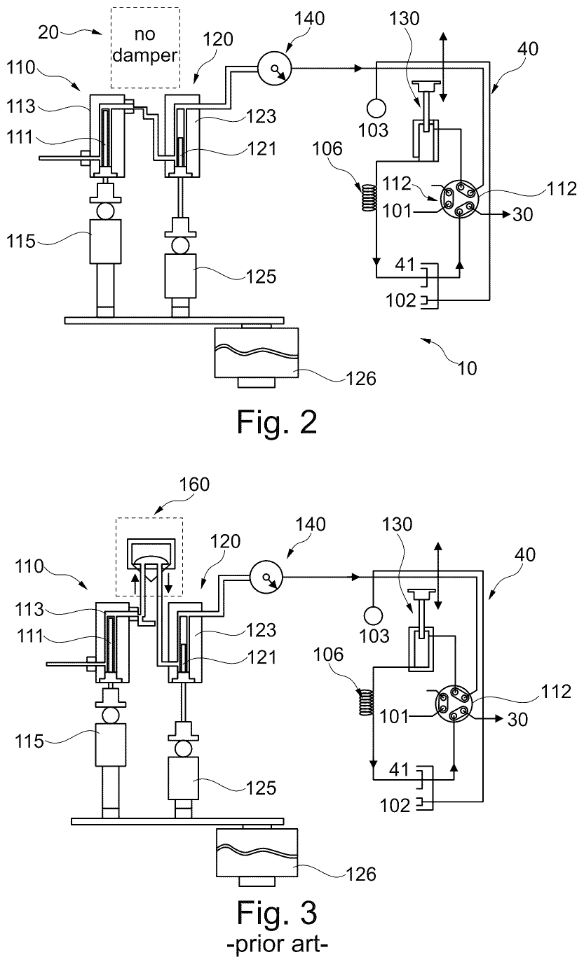

A data processing unit or control device/unit 70 (which can be a PC or workstation, alternatively it can be also a dedicated controller as a hand-held controller, or a processing unit such as microcontroller, microprocessor or plurality of those operating in coordinated manner or at least interacting, contained in or being part of one or more of the system modules 25, 27, 20, 30, 50, 60) may be coupled (as indicated by the dotted arrows) to one or more of the devices in the sample separation device 10 in order to receive information and/or control operation. For example, the control device 70 may control operation of the fluid drive arrangement 20 (for example setting control parameters) and receive therefrom information regarding the actual working conditions (such as output pressure, etc., at an outlet of the pump 20). The control device 70 may also control operation of the solvent supply 25 (for example setting the solvent/s or solvent mixture to be supplied) and/or the degasser 27 (for example setting control parameters such as vacuum level) and might receive therefrom information regarding the actual working conditions (such as solvent composition supplied over time, vacuum level, etc.). The control device 70 might further control operation of the sampler or injector 40 (for example controlling sample injection or synchronization of sample injection with operating conditions of the fluid drive arrangement 20). The control device 70 may be configured to control a metering device (see FIG. 2) of the sampler 40, in particular coordinated with the fluid drive arrangement 20.

The separation unit 30 might also be controlled by the control device 70 (for example selecting a specific flow path or column, setting operation temperature, etc.), and send-in return-information (for example operating conditions) to the control device 70. Accordingly, the detector 50 might be controlled by the control device 70 (for example with respect to spectral or wavelength settings, setting time constants, start/stop data acquisition), and send information (for example about the detected sample compounds) to the control device 70. The control device 70 might also control operation of the fractionating unit 60 (for example in conjunction with data received from the detector 50), which provides data back.

As already mentioned, the sample separation device 10 for separating the fluidic sample according to FIG. 1 comprises the fluid drive arrangement 20, for instance embodied as a pump, comprising two fluid drive units 110, 120 (each configured as a high-pressure pump) for driving a mobile phase along a flow path 108 to sample separation unit 30, which is embodied as a chromatographic separation column. A sample accommodation volume 106 is here embodied as a sample loop and is configured for temporarily accommodating the fluidic sample before injection. The sample accommodation volume 106 is hence configured to be selectively fluidically coupleable with the flow path 108 (for sample injection) or fluidically decoupleable from the flow path 108 (for sample intake). The sample accommodation volume 106 may also be denoted as a sample introduction unit, and may for instance be a sample loop, an injection valve, an autosampler, etc. The sample accommodation volume 106 is responsible for filling (introducing) the fluidic sample into the flow path 108.

FIG. 1 also shows schematically how the sample accommodation volume 106 can be filled with a fluidic sample. For instance, a needle 91 may be temporarily driven out of a needle seat (not shown) of the injector 40 and may be temporarily immersed (see reference numeral 95) into a fluidic sample liquid 92 in a vial or other fluid container 93. An aliquot of the fluidic sample liquid 92 may then be drawn into the sample accommodation volume 106 via the needle 91. The fluidic sample 92 in the sample accommodation volume 106 is then at or close to ambient pressure.

FIG. 2 shows a sample separation device 10 without a damping device 160, in accordance with embodiments of the present disclosure. The fluid drive arrangement 20 comprises a first fluid drive unit 110 with a first piston 111 in a first pump chamber 113 and a second fluid drive unit 120 with a second piston 121 in a second pump chamber 123. While the first fluid drive unit 110 is connected to the mobile phase/solvent container (not shown), the second fluid drive unit 120 is coupled to the sampler 40 and coupleable to the sample separation unit 30. Process direction upstream of the first fluid drive unit 110, there is arranged a first check valve and process direction upstream of the second fluid drive unit 120, there is arranged a second check valve. In this example, the first piston 111 is driven by a first drive unit 115, while the second piston 121 is driven by a second drive unit 125, both drive units 115, 125 (e.g., ball-screws) being coupled via a common gear system to a common motor 126. Using the gear system, the drive units 115, 125 can operate in a different manner, thereby enabling a continuous flow (of mobile phase). This configuration can be termed a dual piston pump system.

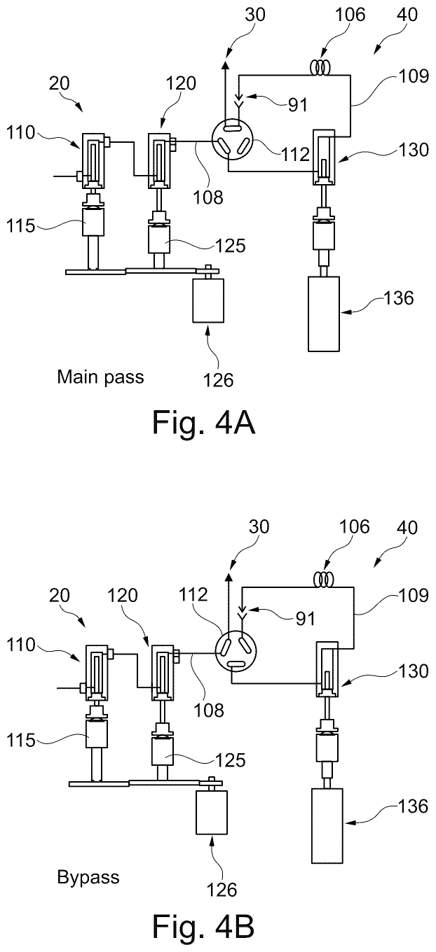

The second fluid drive unit 120 is coupled to a fluid valve, in particular a switching valve 112. In between, a pressure sensor 140 is provided to monitor the pump/system pressure. The switching valve 112 (in this example the injection valve of the sampler 40) enables at least two operation modes: main pass and bypass (see also FIGS. 4A and 4B). In the main pass mode, the fluid drive arrangement 20 is coupled with sampler 40 and the sample separation unit 30. In the bypass mode, the fluid drive arrangement 20 is only coupled with the sample separation unit 30, while the sampler 40 is in sample uptake mode.

The sampler 40 comprises a metering device 130 to take up fluidic sample, e.g. from a sample container using a sample needle. The sample can be stored in a sample accommodation volume 106, e.g. a sample loop. The sample can be introduced into the sample separation unit 30 via a needle seat 41. For example, mobile phase driven by the fluid drive arrangement 20 can flush out the sample from the sample loop 106 in the main pass operation mode. The sampler 40 can further comprise for example a needle wash port 102, a waste line 101, or a wash pump 103.

In order to reduce/eliminate fluctuations in the fluid drive arrangement 20, it may be required to provide a damping capability. However, in comparison to the conventional example of FIG. 3, no additional damping device 160 is used.

Instead, the metering device 130 of the sampler 40 is controlled (specifically the pump piston movement of the metering device 130 is controlled) to actively damp fluctuations in pressure/flow caused by the operation of the fluid drive arrangement 20. In this example, active damping is performed in the main pass configuration, when the fluid drive arrangement 20 and the metering device 130 are connected (via the switching valve 112) in a high-pressure flow path 108 towards the sample separation unit 30.

FIG. 4A shows a sample separation device 10 in main pass configuration, while FIG. 4B shows the sample separation device 10 in bypass configuration, according to exemplary embodiments of the present disclosure.

FIG. 4A shows a sample separation device 10 fluid path in a coupled operation mode (main pass), according to an exemplary embodiment of the present disclosure. The fluid drive arrangement 20 comprises two coupled fluid drive units, a first fluid drive unit 110 and a second fluid drive unit 120 (dual piston pump). It can be seen that each fluid drive unit 110, 120 comprises a piston/cylinder and that both pump units 110, 120 are coupled with each other in series.

The fluid drive arrangement 20 is coupled via the switching valve 112 (e.g., a shear valve and/or a rotary valve) to a piston chamber (pump volume/cylinder) of the metering device 130 of the sampler 40. The piston chamber of the metering device 130 is further connected via a sample accommodation volume 106 to a sample needle 91 (FIG. 1). The metering device 130 is driven by a metering device drive 136. It is further illustrated that the sample needle 91 with a needle seat 41 (FIG. 2) constitutes a high-pressure-tight joint in the flow path, so that the injection path is established and the sample can be transported to the sample separation unit 30 with a flow of a mobile phase. The switching valve 112 connects the sample injection path to the sample separation unit 30.

In this configuration, there is established a high-pressure flow path 108 from the fluid drive arrangement 20, via the metering device 130, to the sample separation unit 30. The metering device 130 is configured as a piston pump, whereby the piston is moved by a metering device drive, e.g. a motor. The movement of the metering device 130 piston is coordinated with the movement of the pistons of the fluid drive arrangement 20, so that an active damping is provided. Specifically, fluctuations such as ripples caused by the fluid drive arrangement 20 are actively damped by the specific movement of the metering device 130 piston.

FIG. 4B shows a sample separation device 10 fluid path in a decoupled operation mode (bypass), in accordance with an embodiment of the present disclosure. The example of FIG. 4B is comparable to the one described for FIG. 4A, yet the switching valve 112 has switched to decouple the sampler 40 (sample path) from the (high-pressure) fluid path 108. It can be seen that the fluid drive arrangement 20 is only coupled, via the switching valve 112, to the sample separation unit 30.

The fluid path 109 of the sampler 40 couples the metering device 130 with the sample accommodation volume 106 and the sample needle 91, and is decoupled from the high-pressure flow path 108 towards the sample separation unit 30. In this configuration, the fluid path 109 of the sampler 40 may be under normal ambient pressure and sample up-take can be performed. Specifically, the needle 91 is placed into a sample container and the metering device 130 draws a specified amount of the fluidic sample into the sample needle 91 and sample accommodation volume 106. In this bypass configuration, the metering device 130 is not coupled to the fluid drive arrangement 20, thus not serving as an active damper. Nevertheless, in the bypass configuration, there is normally no sample separation/analysis done, so that the damping may not be necessary.

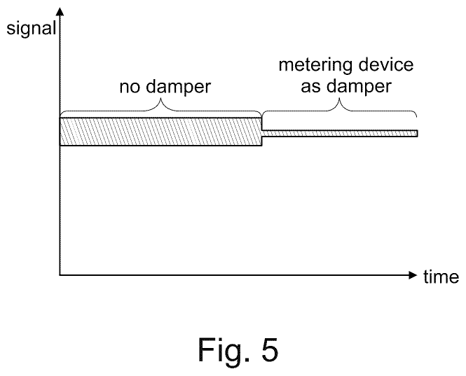

FIG. 5 schematically illustrates in a signal/time diagram the effect of an active damping metering device, according to exemplary embodiments of the present disclosure. The Y-axis shows a signal (e.g., pressure trace envelope) in arbitrary units and the X-axis shows the time in arbitrary units. It can be seen that in case of no damping device (left side, broader signal envelope), a strong fluctuation in the signal can be observed. The fluctuation may be caused by pressure ripples, in particular generated by a dual piston pump. When the metering device 130 starts active damping of the pressure/flow fluctuations (right side, narrow signal envelope), the fluctuations can be immediately damped, so that the disturbance of the chromatographic process and detector signals by pressure/flow fluctuations is reduced or eliminated.

The signal corresponds to a parameter over time which is a result of the operation of the pump, namely pressure, flow, solvent composition, or is substantially affected by one of these parameters, namely the detector signal (absorption, fluorescence, conductivity, refractive index, etc.).

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

### REFERENCE SIGNS

10 Sample separation device
20 Fluid drive arrangement
25 Solvent supply
27 Degasser
30 Sample separation unit
40 Sampler, sample injector
41 Needle seat
50 Detector
60 Fractionating unit
70 Data processing device, control unit
91 Needle
92 Sample
93 Sample container
95 Sample intake
101 Waste
102 Needle wash port
103 Wash pump
106 Sample accommodation volume, sample loop
108 Flow path
109 Decoupled flow path
110 First fluid drive unit
111 First piston
112 Switching unit, fluid valve
113 First pump chamber
115 First drive
120 Second fluid drive unit
121 Second piston
123 Second pump chamber
125 Second drive
126 Common motor
130 Metering device
136 Metering device drive
160 Damper device

1. A sample separation device for separating a fluidic sample, the sample separation device comprising:
a fluid drive arrangement configured to drive a mobile phase along a high-pressure flow path to a sample separation unit;
a sampler configured to sample the fluidic sample, wherein the sampler comprises a metering device; and
a control device configured to control the metering device to perform an active damping to actively damp a fluctuation in an operation of the fluid drive arrangement.

2. The sample separation device of claim 1, wherein the control device is configured to control the metering device and the fluid drive arrangement in a coordinated manner.

3. The sample separation device of claim 1, wherein the active damping by the metering device comprises at least one selected from the group consisting of: balancing pressure; balancing pressure ripples; avoiding fluctuations; correcting a pressure change; correcting a pressure jump; taking up fluid volume if a fluid flow is too high; and providing fluid volume if the fluid flow is too small.

4. The sample separation device of claim 1,
wherein the active damping comprises moving a piston of the metering device in a manner coordinated with at least one selected from the group consisting of: a piston movement of the fluid drive arrangement; and a duty cycle of the fluid drive arrangement.

5. The sample separation device of claim 1, comprising at least one of the following features:
wherein, at least in a main pass configuration, the fluid drive arrangement is coupled with the sample separation unit via the metering device;
wherein, at least in a main pass configuration, the high-pressure flow path extends through the metering device;
wherein, at least in a main pass configuration, the metering device is fluidically coupled to the high-pressure flow path, and the high-pressure flow path connects the fluid drive arrangement and the sample separation unit;
wherein, at least in a bypass configuration, the fluid drive arrangement is decoupled from the metering device and is coupled or decoupled from the sample separation unit.

6. The sample separation device of claim 1, wherein the fluid drive arrangement comprises a first fluid drive unit and a second fluid drive unit, and the first fluid drive unit and the second fluid drive unit are fluidically coupled with each other.

7. The sample separation device of claim 1, comprising a switching device configured to couple and/or decouple the fluid drive arrangement and the metering device to switch between a main pass configuration and a bypass configuration.

8. The sample separation device of claim 7, wherein the switching device has a configuration according to at least one of the following:
the switching device is configured to allow the metering device to draw fluidic sample into a sample accommodation volume while being fluidically decoupled from the high-pressure flow path;
the switching device is configured to fluidically couple the fluid drive arrangement and the sample separation unit;
the switching device is configured to fluidically couple the fluid drive arrangement and the sample separation unit in the high-pressure flow path;
the switching device is configured to introduce the sample accommodation volume into the high-pressure flow path in a flow-through mode;
the switching device is configured to allow introduction of the sample into the high-pressure flow path in a feed injection mode;
the switching device is configured to allow pressurizing and/or depressurizing of the sample accommodation volume while the sample accommodation volume is decoupled from the high-pressure flow path.

9. The sample separation device of claim 1, comprising at least one of the following:
a pressure sensor selected from the group consisting of: a pressure sensor of the fluid drive arrangement; a pressure sensor permanently or temporarily connected to or into the high-pressure flow path or sub-sections thereof; and a pressure sensor of the sampler;
a pressure sensor, wherein the control device is configured to control the metering device at least partially based on at least one selected from the group consisting of: at least one pressure measurement of the pressure sensor; a model predicting the fluid volume displaced by the fluid drive arrangement over time; and calculated or measured positions of pistons of the fluid drive arrangement.

10. The sample separation device of claim 1, wherein the sample separation device is free of a damping device of the fluid drive arrangement.

11. The sample separation device of claim 1, comprising one of the following features:
wherein the metering device is configured to adjust a dead volume;
wherein the metering device is configured to adjust a dead volume for an instrument emulation mode.

12. The sample separation device of claim 1, comprising at least one of the following features:
wherein the fluid drive arrangement comprises a first fluid drive unit and a second fluid drive unit, and the first fluid drive unit is configured to draw a solvent or a mobile phase from a solvent or mobile phase container, and then stream the solvent or mobile phase to the second fluid drive unit;
wherein the fluid drive arrangement is configured to stream a mobile phase through a sample accommodation volume of the sampler, thereby flushing out the fluidic sample accommodated in the sample accommodation volume by the mobile phase.

13. The sample separation device of claim 1, comprising at least one of the following features:
wherein the sampler is configured to introduce the fluidic sample into the mobile phase;
wherein the metering device is configured to move the fluidic sample and/or to pressurize or depressurize a sample accommodation volume of the sampler before and/or after introduction of the fluidic sample into a mobile phase.

14. The sample separation device of claim 1, wherein the active damping is provided when the metering device is in fluid communication with the fluid drive arrangement.

15. The sample separation device of claim 1, wherein the fluid drive arrangement comprises a first fluid drive unit and a second fluid drive unit, and the sample separation device further comprises at least one of the following features:
wherein the first fluid drive unit and the second drive unit are connected to a common motion source;
wherein the first fluid drive unit and the second drive unit are mechanically dependent from each other;
wherein the first fluid drive unit is arranged in process direction upstream of the second fluid drive unit.

16. The sample separation device according to claim 1, wherein the sample separation device is configured as a fluidic chromatography device.

17. A method for operating a sample separation device, the method comprising:
driving a mobile phase along a high-pressure flow path to a sample separation unit by operation of a fluid drive arrangement; and
controlling a metering device of a sampler of the sample separation device to thereby actively damp a fluctuation in an operation of the fluid drive arrangement.

18. The method of claim 17, wherein the metering device is controlled dynamically.

19. The method of claim 17, comprising coordinating the operation of the fluid drive arrangement and the active damping by the metering device.
